(19) United States
(12) Patent Application Publication
(10) Pub. No.: US 2026/0027734 A1
(43) Pub. Date: Jan. 29, 2026

(54) Holding frame and construction robot having a tool interface

(71) Applicant: Hilti Aktiengesellschaft, Schaan (LI)

(72) Inventors: Tobias SCHMID, Emmenhausen (DE); Markus HARTMANN, Mauerstetten (DE); Michael NITZSCHNER, Augsburg (DE); Florian HURKA, Margertshausen (DE); Georg FÜRFANGER, München (DE); David WÖHRLE, Landsberg (DE); Peter BRUGGER, Feldkirch (AT); Rory BRITZ, Starnberg (DE)

(21) Appl. No.: 18/997,282

(22) PCT Filed: Jul. 21, 2023
(86) PCT No.: PCT/EP2023/070304

§ 371 Date: Jan. 21, 2025

(30) Foreign Application Priority Data
Aug. 3, 2022 (EP) 22188419.0
Oct. 26, 2022 (EP) 22203844.0

(51) Int. Cl. B25J 15/04; B25J 5/00; B25J 11/00; B25J 15/00; B25J 19/00

(52) U.S. Cl. CPC B25J 15/04; B25J 5/007; B25J 11/005; B25J 15/0019; B25J 19/0091

(57) ABSTRACT

A holding frame (22) for receiving a tool (24) which has a storage battery interface (58) for receiving a storage battery (60) such that the latter is detachable, in particular detachable without the use of tools. The holding frame (22) has a holding portion (70) that is designed complementarily to the storage battery interface (58). The holding frame (22) furthermore has an attachment point (80) for attachment to a manipulator (18) of a construction robot (10). A construction robot (10) is also provided. The invention inexpensively allows particularly versatile use of the construction robot (10).

The invention is concerned with the performance of construction tasks by means of a construction robot. In particular, the invention relates to a construction robot having a manipulator, on which a tool interface is situated, and to a holding frame for a tool.

### BACKGROUND

There is a high demand for inexpensive living and working space. Intensive efforts are presently being made to lower the costs for producing buildings, and to furthermore reduce health risks for construction workers, through the most extensive possible use of automation. For this purpose, increasing use is being made of construction robots.

### SUMMARY OF THE INVENTION

Owing to their complexity, however, construction robots have hitherto been very expensive to produce.

It is desirable to be able to utilize construction robots to the greatest possible degree in order to be able to lower time-related costs. The more flexible the construction robot is in use, in particular the sooner the construction robot can be used for different types of construction tasks, the sooner this can be achieved.

It is an object of the present invention to offer solutions that allow the greatest possible variety of construction tasks to be performed by means of one construction robot.

The present invention provides a holding frame for receiving a tool which has a storage battery interface for receiving a storage battery such that the latter is detachable, in particular detachable without the use of tools, wherein the holding frame has a holding portion which is designed complementarily with respect to the storage battery interface, and wherein the holding frame has an attachment point for attachment to a manipulator of a construction robot.

The tool for which the holding frame is provided may in particular be a handheld power tool that can be powered by a rechargeable storage battery.

The tool can thus be arranged on the holding frame, wherein the holding portion engages into the storage battery interface such that the tool can be easily fixed to the holding frame.

It is thus possible for different tools, in particular different types of tools, to be securely arranged on the same holding frame.

It is possible here to utilize the fact that different types of tools often have the same storage battery interfaces. This may apply in particular to storage-battery-powered tools, for example storage-battery-powered handheld power tools such as hand drills, in particular rock drills, nail guns, grinding machines, power saws, power chisels or the like.

Here, the storage battery interface may perform at least two functions: firstly, the storage battery interface may be designed to securely hold the storage battery on the power tool.

Secondly, the storage battery interface may be configured to transmit operating energy. Here, the operating energy may be transmissible unidirectionally, in particular from the storage battery to the power tool. It may also be transmissible bidirectionally, for example for the purposes of recharging the storage battery by way of recuperation. The storage battery interface may have yet further functions. In particular, it may also be configured for transmitting signals between the storage battery and the power tool. Said signal transmission may also be unidirectional or bidirectional.

The storage battery interface may for example have guide rails. The holding frame may have a carriage which is designed complementarily to the guide rails. The holding frame can then be pushed with its carriage onto the guide rails. The storage battery interface and/or the holding frame may have a latching mechanism. The holding frame can then be latched on the storage battery interface after having been pushed onto the guide rails. The latching mechanism may be designed to be releasable without the use of tools.

In one class of exemplary embodiments, the holding frame may have a bearing arm, situated at a different point than the holding portion, for additionally supporting the tool. The holding frame may in particular be designed to support the tool at multiple different points, in particular to hold said tool at the multiple points. By means of such multi-point support, torques that arise during the operation of the tool can be better absorbed by the holding frame. If required, said torques can be better counteracted.

If the tool is designed as a handheld power tool, it often has a connecting portion for a side handle. The bearing arm of the holding frame may then be positioned such that, when the holding frame has been installed on the storage battery interface, said bearing arm holds, for example engages around, the tool at the connecting portion of the tool.

In order to avoid excessive loading of and in particular damage to the manipulator, the holding frame may have at least one vibration damper. The vibration damper may have foam material and/or an elastic or at least partially elastic material. Said vibration damper may be configured to reduce a transmission of vibrations from the power tool to the rest of the holding frame.

At least one electrical connection may be formed between the holding portion and the attachment point. It is thus possible for electrical current, for example for the supply of operating energy to the tool or for the transmission of signals, to be transmitted unidirectionally or bidirectionally between the holding portion and the attachment point, and thus between the tool installed in the holding frame and the manipulator installed on the holding portion.

In order to be able to use as many different types of tools as possible with the holding frame and consequently with a particular construction robot, it is advantageous to adapt the electrical connection to electrical parameters of the tool and/or of the construction robot. For this purpose, the holding frame may have a converter for converting at least one electrical parameter along the electrical connection. The converter may for example be a DC/DC converter, an AC/DC converter, a DC/AC converter, an amplifier, a limiter, an impedance converter, a signal code converter or the like. The converter may be remote-controllable and/or programmable. It is thus conceivable for a user of the holding frame and/or the construction robot to program and/or remote-control the converter based on a type of tool which is to be installed and/or which has been installed.

In particular, if different tools are available which have in each case one of at least two types of storage battery interfaces, it is conceivable to provide at least two different holding frames of the type described above, wherein the at least two different holding frames each have an attachment point that is designed complementarily to in each case one of the other types of storage battery interfaces.

The present invention furthermore provides a construction robot for performing construction tasks on a building construction site, on a civil engineering construction site and/or in steel construction, for example on a gas or oil platform, comprising an in particular motorized mobile platform, and comprising a manipulator, wherein the manipulator has a tool interface which is designed complementarily to the attachment point of a holding frame of the type described here.

A tool can thus be installed in the holding frame, in particular on the storage battery interface. The holding frame can in turn be installed with its attachment point on the tool interface of the manipulator. A type, a shape and/or other specifications of the tool are thus abstracted by the holding frame. A uniform facility can thus be formed for attaching systems composed of holding frame and tool to the construction robot. A large number of easily available and thus inexpensive tools can thus be used with the construction robot.

In order to temporarily store tools, the construction robot may have a storage magazine. At least one tool can be received in the storage magazine, in particular by means of a holding frame of the type described here.

A holding frame of the type described here may be installed on the manipulator. A tool may be arranged, in particular by way of its storage battery interface, on the holding frame.

It is conceivable for the tool to be configured such that at least one tool function, for example a motor power, a rotational frequency and/or an operating mode, is controllable via the storage battery interface of said tool and/or wirelessly. The construction robot can thus control the tool in order, for example, to perform a construction task or at least a part of the construction task using the tool.

For this purpose, it is conceivable for the tool to have a data interface. The data interface may be integrated into the storage battery interface. Said data interface may alternatively or additionally also be radio-based. The tool may then be remote-controllable via the data interface.

For example, the data interface may be configured to transmit control commands, property data, and/or state data.

For example, an operating mode and/or an operating state of the tool can thus be controlled. In particular, the tool may be capable of being switched on and/or switched off by remote control.

It is also conceivable that at least one level of working power, direction of rotation, rotational frequency, torque or impact frequency are settable by remote control.

In the case of tools which have an impact function, it can be particularly expedient if the impact function is also settable by remote control. Thus, for example in order to drill a hole in concrete, the construction robot may commence drilling with the impact function deactivated and may activate the impact function later, so as to minimize the risk of undesired chipped borehole edges.

The tool may be configured to provide property data, for example in the form of at least one item of identification data, performance capability, for example maximum available impact energy and/or maximum available working power, in a retrievable manner, in particular retrievably via the data interface.

It is also conceivable for the tool to be configured to provide at least one operating state of the power tool, for example at least one rotational speed, temperature, measure of wear of one of the components, or the like, in a retrievable manner, in particular retrievably via the data interface.

For this purpose, it is advantageous if the data interface is designed to be bidirectional. It is then for example possible both for control commands to be transmitted from the construction robot to the tool and for property and/or state data to be transmitted from the tool to the construction robot. It is also conceivable here that control commands and/or property and/or state data can alternatively or additionally also be transmitted in the opposite direction in each case.

The tool may have at least one protection device for protecting a user during manual use of the power tool. The protection device may for example be a start lock, in particular a restart lock, which prevents the motor from starting simply as a result of a supply voltage being applied, in particular without additional actuation of an actuating element.

The construction robot may be designed for carrying out construction work on a building construction site and/or on a civil engineering construction site and/or in an in particular steel-based industrial plant, for example on an oil platform. It may be configured for performing construction work on a ceiling, a wall and/or a floor. In may be designed for drilling, cutting-off, chiseling, grinding and/or setting a structural element. It may have one or more tools. The at least one tool may be installed on the construction robot, in particular on the manipulator, by means of the holding frame. The tool may comprise a cutting-off tool, a grinding tool, and/or a setting tool. It is also conceivable for the tool to be designed for marking. The tool may for example have a paint spray gun. It may alternatively or additionally also have a measuring tool, for example a distance meter.

The construction robot may have a manipulator. The manipulator may be formed as a robot arm. The manipulator may also have a lifting device. The lifting device can increase the size of the overall volume which can be reached by the manipulator. The manipulator may have at least three degrees of freedom. In particular, it may have at least six degrees of freedom.

The construction robot may also have a mobile platform. The mobile platform may comprise a wheeled undercarriage and/or a track-chain undercarriage. The mobile platform may have at least two degrees of freedom. The construction robot may have altogether at least ten degrees of freedom. It is alternatively also conceivable that the mobile platform is or comprises a flying platform. For example, the construction robot may also be designed as a flying drone.

Further features and advantages of the invention are apparent from the detailed description of exemplary embodiments of the invention that follows, with reference to the figures of the drawing which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and elucidated in detail in the description that follows.

### BRIEF DESCRIPTION OF THE DRAWINGS

FIG. 1 shows a construction robot;

FIG. 2 shows a tool having a storage battery interface;

FIG. 3 shows a schematic side view of a tool received in a holding frame;

FIG. 4 is a schematic cross-sectional view of a storage battery interface having a holding portion received therein;

FIG. 5 is a schematic illustration of a holding frame having an electrical connection and a converter; and

FIG. 6 a schematic illustration of a holding frame having vibration dampers in which a tool is received.

### DETAILED DESCRIPTION

In the description of the figures that follows, comprehension of the invention is facilitated by use of the same reference numerals in each case for identical or functionally corresponding elements.

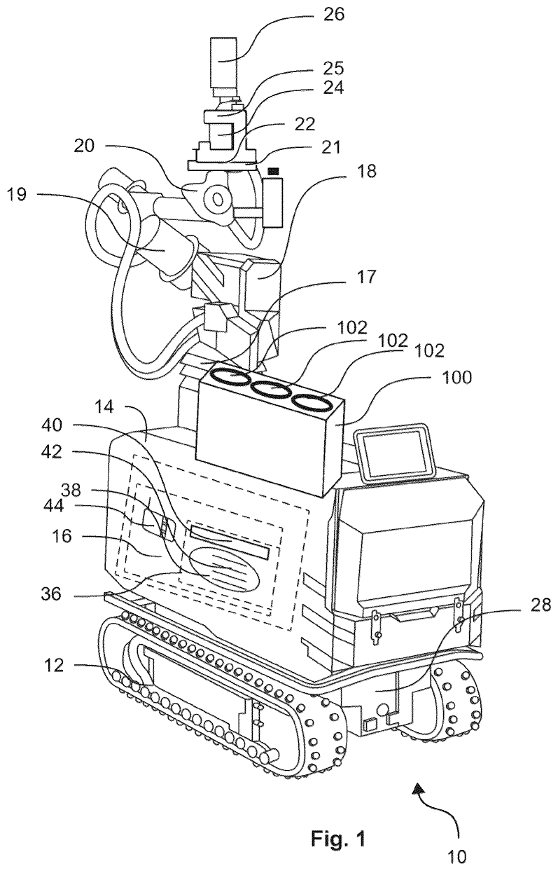

FIG. 1 shows a construction robot 10 having a motorized undercarriage 12 designed as a track-chain undercarriage, having a control space 16 formed in a housing 14, and having a manipulator 18 arranged on top of the housing 14. The manipulator 18 comprises a lifting device 17 for vertical movement and a multiaxially controllable arm 19.

An end effector 20 having a tool interface 21 is situated at the free end of the arm 19.

A tool 24, in particular a rock drill power tool with a dust extraction device 26, is detachably arranged on the tool interface 21.

In order for the tool 24 to be detachably arranged on the tool interface 21, the tool is received in a holding frame 22. As will be discussed in more detail further below, the holding frame 22 is connected to the tool 24 via a storage battery interface of said tool.

The holding frame 22 is installed on the tool interface 21. For this purpose, the tool interface 21 is configured for detachable connection of the holding frame 22 and thus also of the tool 24.

The holding frame 22 has a bearing arm 25 by which the tool 24 is additionally supported by the holding frame 22.

The construction robot 10 is supplied with operating energy by an energy store 28, in particular in the form of a rechargeable, lithium-based storage battery. Said construction robot can thus be used wirelessly.

The construction robot 10 furthermore has a storage magazine 100. The storage magazine 100 has multiple storage spaces 102. The tool 24 can be placed into free storage spaces 102 in order to be stored and reused later when required. Further elements, for example further tools, may also be stored in the storage spaces 102 for later use, in particular with the construction robot 10. Tools received in the storage magazine 100 are preferably likewise equipped with holding frames corresponding to the holding frame 22, such that said tools can likewise be installed, by way of their respective holding frames, on the tool interface 21.

The construction robot 10 has, preferably within the housing 14, a controller 36 arranged in the control space 16. The controller 36 comprises a memory module 38 and a microprocessor 40.

The controller 36 is equipped with executable program code 42. The program code 42 is retrievable and is stored on the microprocessor 40 so as to be executable in the memory module 38. Via a communication interface 44, the controller 36 can contact a cloud-based computer system (not illustrated in FIG. 1) and can exchange data, for example data relating to the nature of construction tasks to be carried out, associated position and/or situation data, and/or control commands.

The construction robot 10 is designed for performing construction tasks, for example drilling work in ceilings and walls, on a construction site, in particular on a building construction site, on a civil engineering construction site and/or on a steel structure construction site, for example on an oil or gas production platform. In particular, the controller 36 may control the manipulator 18 such that construction work can be performed on ceilings and walls. One example of such a construction task may for example be drilling a borehole, in particular with a particular bore depth and/or a particular borehole diameter, into a concrete ceiling using the tool 24 designed as a rock drill power tool.

The construction robot 10 is configured to automatically detach the tool 24 that is arranged on the tool interface 21 from said tool interface and to install a second tool on the tool interface 21. By means of its manipulator 18, the construction robot 10 can move the tool 24 to a free storage space 102 and then detach the holding frame 22 from the tool interface 21. The second tool can be picked up from one of the other storage spaces 102 and installed by way of its holding frame on the tool interface 21.

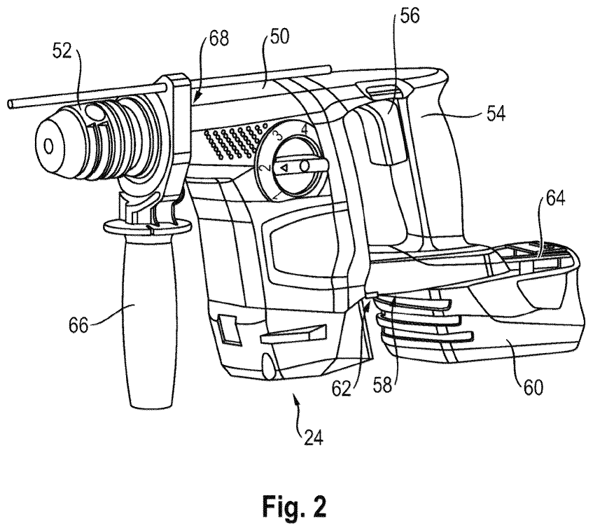

FIG. 2 shows a tool 24. The tool 24 is a storage-battery-powered rock drill power tool. It can be received in the holding frame 22 (see FIG. 1).

The tool 24 has a basic body 50, out of one end of which a tool fitting 52 projects. The tool fitting 52 is designed to receive drilling or chiseling tools. It can be driven in rotation and/or with percussive action by a motor situated within the basic body 50.

At the other end, it has a handle 54. Situated on the handle 54 is an actuating element 56 which can be used to manually control the tool 24. In particular, the actuating element 56 can be used to start and stop a drilling operation or to regulate a rotational speed.

Furthermore, the tool 24 has a storage battery interface 58. The storage battery interface 58 is designed to receive rechargeable storage batteries, for example the storage battery 60. It serves, for example when the tool 24 is used manually, inter alia for fixing the storage battery 60 to the tool 24, for transmitting operating energy between the storage battery 60 and the tool 24, and for transmitting signals between same.

In the situation illustrated in FIG. 2, the storage battery 60 has been pushed approximately halfway onto the storage battery interface 58. The storage battery interface 58 has a latching mechanism 62, which for illustrative purposes is merely schematically indicated in FIG. 2. The latching mechanism 62 is designed such that the storage battery 60 that has been pushed all the way onto the storage battery interface 58 is acted on by a resistance force, such that the storage battery 60 can be removed from the storage battery interface 58 when the resistance force generated by the latching mechanism 62 is overcome. The latching mechanism 62 thus allows installation and uninstallation without the use of tools, and nevertheless allows the storage battery 60 that has been pushed all the way on to be seated sufficiently firmly on the tool 24.

In order to enable the storage battery 60 to be installed on the storage battery interface 58, the storage battery 60 has a storage battery attachment point 64 which is designed complementarily to the storage battery interface 58. The tool 24 can also be supplied with operating energy from the storage battery 60 via the storage battery interface 58.

The storage battery interface 58 is also configured to receive control signals by means of which at least one function of the tool 24, for example the aforementioned functions of the actuating element 56, can be controlled.

The tool 24 furthermore has an additional handle 66 which is arranged on the basic body 50 in a holding region 68 in the vicinity of the tool fitting 52.

The additional handle 66 can be uninstalled.

The bearing arm 25 of the holding frame 22 (both visible in FIG. 1) is designed complementarily to the holding region 68, and may at least partially surround said holding region when the tool 24 is received in the holding frame 22.

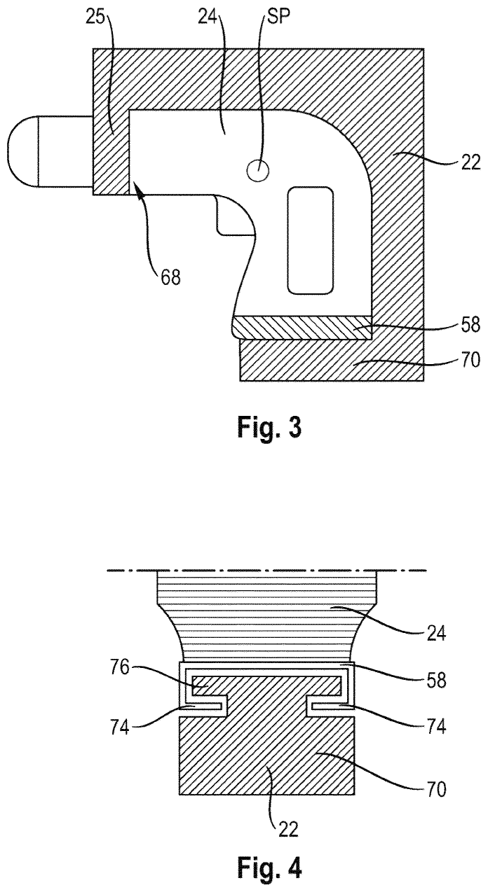

FIG. 3 shows a schematic side view of a tool 24 received in a holding frame 22. It can be seen in particular that the holding frame 22 largely encloses the tool 24.

The tool 24 is held at two points in the holding frame 22. In particular, the tool is held by way of its storage battery interface 58 and a holding portion 70 of the holding frame 22, and by way of its holding region 68, which is at least partially engaged around and thus additionally supported by the bearing arm 25 of the holding frame 22. The bearing arm 25 is situated at a different point of the holding frame 22 than the holding portion 70. Said bearing arm is in particular situated outside a center of gravity SP of the tool 24, so as to also be able to at least partially absorb, and for example counteract, any torques that occur about said center of gravity SP when the tool 24 is in operation.

FIG. 4 schematically shows a cross section through a storage battery interface 58, with a holding portion 70 of the holding frame 22 received therein.

The storage battery interface 58 has lateral guide rails 74.

The holding portion 70 is designed complementarily to the storage battery interface 58, in particular to the guide rails 74. By way of a slide-in portion 76, the holding portion 70 engages behind the guide rails 74.

The tool 24 and the holding portion 70 are thus connected to one another by way of a form fit.

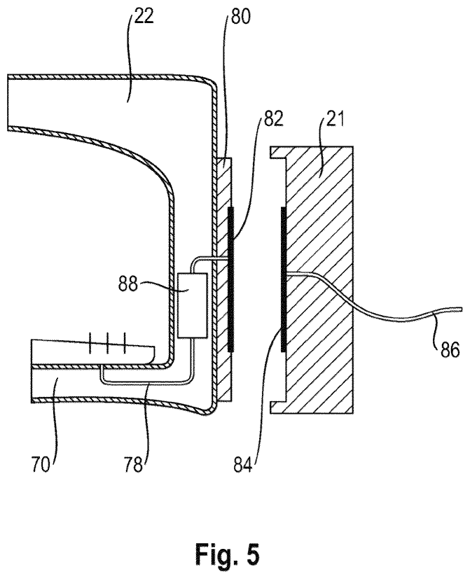

FIG. 5 schematically illustrates cross sections of the holding frame 22 and of the tool interface 21.

An electrical connection 78 electrically connects the holding portion 70 to an attachment point 80 of the holding frame 22.

The attachment point 80 is designed complementarily to the tool interface 21, such that the holding frame 22 can be installed, at the attachment point 80, on the tool interface 21. To simplify the illustration, FIG. 5 shows a state in which the holding frame 22 has not yet been installed on the tool interface 21.

The attachment point 80 and the tool interface 21 have electrical contacts 82, 84, by means of which the tool interface 21 can be connected to the electrical connection 78 and thus also electrically connected to the holding portion 70. It is thus ultimately possible for the tool 24 (see for example FIG. 1) that is installed on the holding frame 22 to be supplied with operating energy via a supply line 86, which is connected at one end to the contact 84 and at the other end to an energy source, for example the energy store 28 (see FIG. 1), of the construction robot 10 (see FIG. 1).

Control signals for controlling the tool 24 can also be transmitted via the supply line 86 from the rest of the construction robot 10 (see FIG. 1) to the tool 24 when the tool 24 has been installed in the holding frame 22.

A converter 88 is integrated into the electrical connection 78. In this exemplary embodiment, the converter 88 is a programmable DC/DC converter. The programming may be implemented by means of suitable programming signals that are applied to the electrical contact 82.

It is thus possible for the operating energy that is transmitted via the contact 82, in the exemplary embodiment in the form of a DC voltage of for example approximately 48 V, to be adapted to a DC voltage that is suitable for the tool 24, for example approximately 22 V.

In order to be able to utilize different types of tools, the converter 88 may be programmed for a large number of different output voltages.

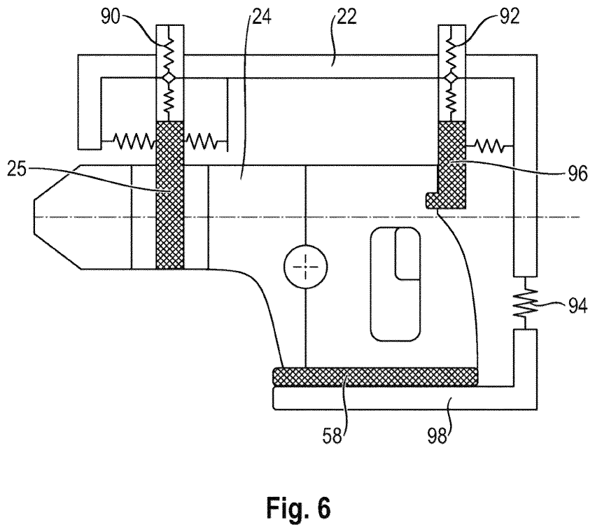

FIG. 6 is a highly schematic illustration of an alternative holding frame 22. Unless described otherwise, said holding frame 22 corresponds to the embodiment of the holding frame 22 described above.

Again, the tool 24 is received in the holding frame 22.

The holding frame 22 has multiple vibration dampers 90, 92, 94.

The vibration dampers 90, 92, 94 have in each case one or more spring elements. They are designed, in particular arranged, such that vibrations originating from the tool 24 are transmitted to the holding frame 22, and possibly from there to a construction robot 10 (see FIG. 1) on which the holding frame 22 is installed, only after having been dampened.

The vibration dampers 90, 92, 94 also dampen undesired vibrations in the opposite direction.

Aside from the bearing arm 25, the holding frame 22 has a second bearing arm 96, such that the tool 24 is held by the holding frame 22 at a total of three points.

The vibration damper 94 is integrated in the holding frame 22. Vibrations acting on a lower part 98 of the holding frame 22 are thus transmitted to the rest of the holding frame 22 only after having been dampened. The lower part 98 is in turn fixedly connected via the storage battery interface 58 to the tool 24.

### LIST OF REFERENCE SIGNS

10 Construction robot
12 Undercarriage
14 Housing
16 Control space
17 Lifting device
18 Manipulator
19 Arm
20 End effector
21 Tool interface
22 Holding frame
24 Tool
25 Bearing arm
26 Dust extraction device
28 Energy store
36 Controller
38 Memory module
40 Microprocessor
42 Program code
44 Communication interface
50 Basic body
52 Tool fitting
54 Handle
56 Actuating element
58 Storage battery interface
60 Storage battery
62 Latching mechanism
64 Storage battery attachment point
66 Auxiliary handle
68 Holding region
70 Holding portion
74 Guide rails
76 Slide-in portion
78 Electrical connection
80 Attachment point
82 Contact
84 Contact
86 Supply line
88 Converter
90 Vibration damper
92 Vibration damper
94 Vibration damper
96 Bearing arm
98 Part
100 Storage magazine
102 Storage space
SP Center of gravity

1-9. (canceled)

10. A holding frame for receiving a tool having a storage battery interface for receiving a detachable storage battery detachable without the use of tools, the holding frame comprising:
a holding portion designed complementarily with respect to the storage battery interface; and
an attachment point for attachment to a manipulator of a construction robot.

11. The holding frame as recited in claim 10 further comprising a bearing arm situated at a different point than the holding portion for additionally supporting the tool.

12. The holding frame as recited in claim 10 further comprising at least one vibration damper.

13. The holding frame as recited in claim 10 further comprising at least one electrical connection formed between the holding portion and the attachment point.

14. The holding frame as recited in claim 13 further comprising a converter for converting at least one electrical parameter along the electrical connection.

15. A construction robot for performing construction tasks on a building construction site, on a civil engineering construction site or in steel construction, the construction robot comprising:
a mobile platform; and
a manipulator having a tool interface designed complementarily to the attachment point of the holding frame as recited in claim 10.

16. The construction robot as recited in claim 15 further comprising a storage magazine, the tool being received by the holding frame in the storage magazine.

17. The construction robot as recited in claim 15 wherein the holding frame is installed on the manipulator, the tool being arranged on the holding frame.

18. The construction robot as recited in claim 15 wherein the tool is configured such that at least one tool function is controllable via the storage battery interface of the tool or wirelessly.

19. The construction robot as recited in claim 18 wherein the at least one tool function includes a motor power, a rotational frequency or an operating mode.

20. The construction robot as recited in claim 15 wherein the construction robot is an gas or oil platform construction robot.

21. The construction robot as recited in claim 15 wherein the vehicle platform is a motorized mobile platform.
